(19) United States
(12) Patent Application Publication
(10) Pub. No.: US 2026/0052244 A1
(43) Pub. Date: Feb. 19, 2026

(54) ENCODING AND DECODING METHODS OF INTRA PREDICTION MODES USING DYNAMIC LISTS OF MOST PROBABLE MODES AND CORRESPONDING APPARATUSES

(71) Applicant: INTERDIGITAL CE PATENT HOLDINGS, SAS, Paris (FR)

(72) Inventors: Ya CHEN, Rennes (FR); Thierry DUMAS, Rennes (FR); Kevin REUZE, Rennes (FR); Gagan Bihari RATH, Rennes (FR)

(21) Appl. No.: 19/128,391

(22) PCT Filed: Nov. 6, 2023
(86) PCT No.: PCT/EP2023/080832

§ 371 Date: May 8, 2025

(30) Foreign Application Priority Data
Nov. 10, 2022 (EP) 22315274.5

(51) Int. Cl. H04N 19/11; H04N 19/159; H04N 19/176; H04N 19/196

(52) U.S. Cl. CPC H04N 19/11; H04N 19/159; H04N 19/176; H04N 19/196

(57) ABSTRACT

An encoding method is disclosed. An intra prediction mode is first obtained for a current block to be encoded. To encode the obtained intra prediction mode, a list of intra prediction modes is obtained comprising a set of intra prediction modes ordered as a decreasing order of their occurrences. In an example, the set of intra prediction modes ordered as a decreasing order of their occurrences comprises intra prediction modes of neighboring blocks of said current block.

### CROSS REFERENCE TO RELATED APPLICATIONS

This application claims the benefit of European Application No. 22315274.5, filed on Nov. 10, 2022, which is incorporated herein by reference in its entirety.

### TECHNICAL FIELD

At least one of the present embodiments generally relates to a method and an apparatus for encoding and decoding a picture block, and more particularly to a method and an apparatus for encoding and decoding intra prediction information.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

In one embodiment, an encoding method is disclosed. An intra prediction mode is first obtained for a current block to be encoded. To encode the obtained intra prediction mode, a list of intra prediction modes is obtained comprising a set of intra prediction modes ordered according to how frequently each intra prediction mode occurs (e.g., in a decreasing order of their frequency of occurrence). In an example, the set of intra prediction modes ordered as a decreasing order of their occurrences comprises intra prediction modes of neighboring blocks of the current block.

In another embodiment, a decoding method is disclosed. Encoded data are first obtained for a current block to be decoded. To decode an intra prediction mode for the current block, a list of intra prediction modes is obtained comprising a set of intra prediction modes ordered as a decreasing order of their occurrences.

An intra prediction mode is thus decoded from the obtained encoded data responsive to the list of intra prediction modes.

### BRIEF DESCRIPTION OF THE DRAWINGS

FIG. 1 illustrates a block diagram of a system within which aspects of the present embodiments may be implemented:

FIG. 2 illustrates a block diagram of an embodiment of a video encoder;

FIG. 3 illustrates a block diagram of an embodiment of a video decoder;

FIG. 4 illustrates the principles of directional intra prediction with reference neighbor samples;

FIG. 5 depicts the directional intra modes defined in Versatile Video Coding and Exploratory Coding Model:

FIG. 6 illustrates the principles of Matrix Weighted Intra Prediction method;

FIGS. 7 and 8 illustrate the principles of Decoder side Intra Mode Derivation method;

FIG. 9 illustrates the principles of fusion for template-based intra mode derivation;

FIG. 10 depicts an example of 4 reference lines to be used by Multiple reference line intra prediction process;

FIG. 11 illustrates the division of vertical or horizontal division of luma intra-predicted blocks as used by Intra Sub-Partitions process;

FIG. 12 illustrates the signaling of the intra prediction modes in ECM;

FIG. 13 illustrates the Most Probable Mode (MPM) list generation in ECM;

FIGS. 14 and 15 depict a current block with its neighboring blocks used for MPM list generation in ECM;

FIGS. 16A and 16B depict a current block with its neighboring blocks used for MPM list generation according to an example;

FIGS. 17-19 depict a current block with its neighboring blocks used for MPM list generation according to various examples:

FIG. 20 depict a flowchart of an encoding method according to an embodiment:

FIG. 21 depict a flowchart of a decoding method according to an embodiment:

FIG. 22 illustrates an example of a neighboring block split into two parts by Spatial Geometric Partitioning Mode process which generates two corresponding intra-prediction modes: and

FIGS. 23-24 depict a current block with its neighboring blocks used for MPM list generation according to various examples.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

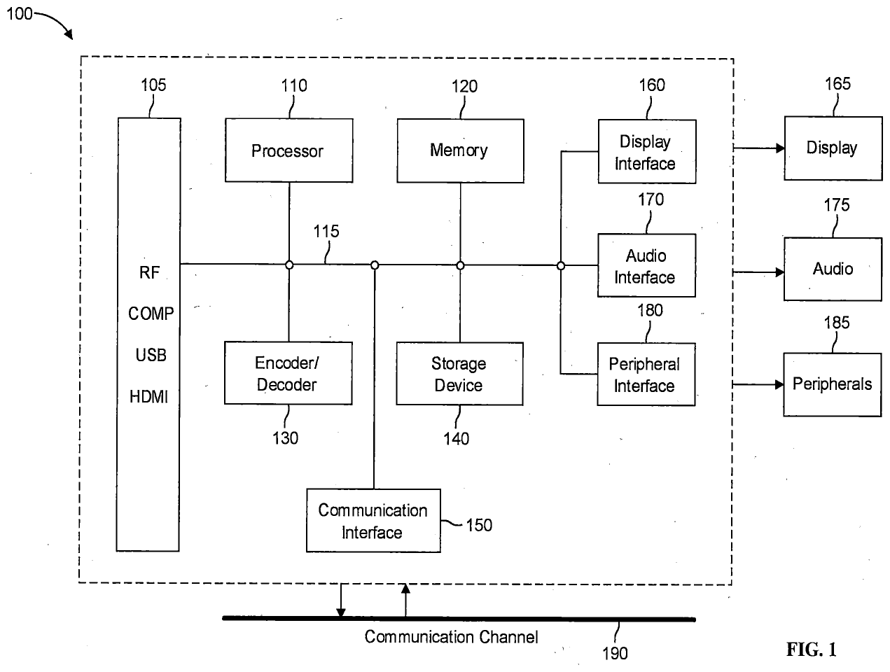

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “MPM list” and “MPM set” may be used interchangeably, the terms “encoded” or “coded” may be used interchangeably, the terms “pixel” and “sample” may be used interchangeably and the terms “image,” “picture” and “frame” may be used interchangeably. Usually, but not necessarily, the term “reconstructed” is used at the encoder side while “decoded” is used at the decoder side. In the following, the terms “intra mode”, “intra prediction mode”, “directional intra prediction mode”, “directional prediction mode”, “directional intra mode”, “directional mode”, “angular mode” and “angular intra prediction mode” are used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1. include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

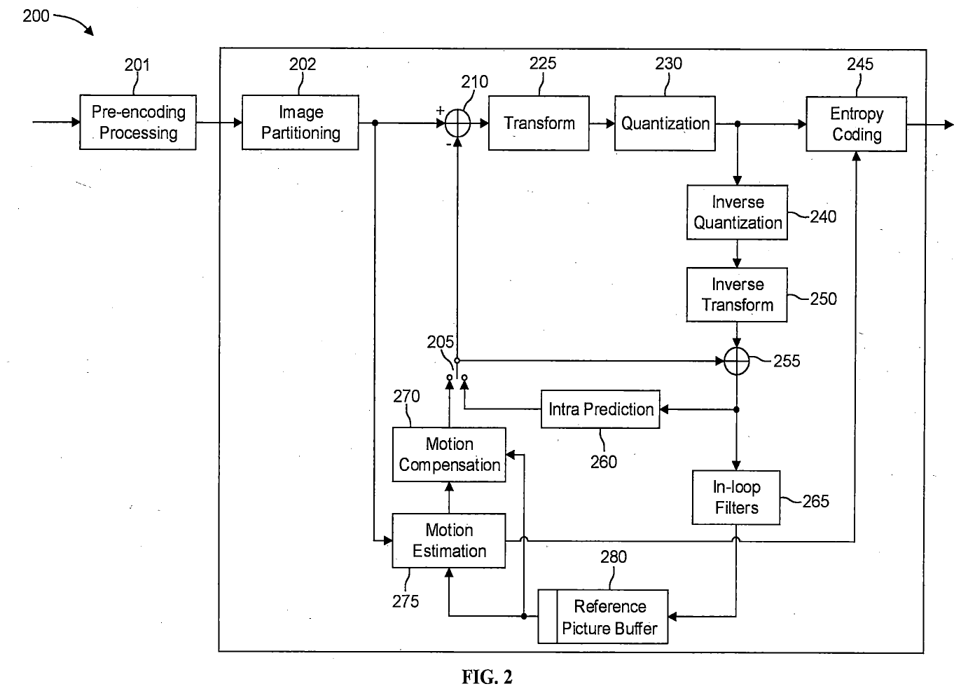

FIG. 2 illustrates an example video encoder 200, such as a VVC (Versatile Video Coding) encoder. FIG. 2 may also illustrate an encoder in which improvements are made to the VVC standard or an encoder employing technologies similar to VVC.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260), e.g. using an intra-prediction tool such as Decoder Side Intra Mode Derivation (DIMD). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

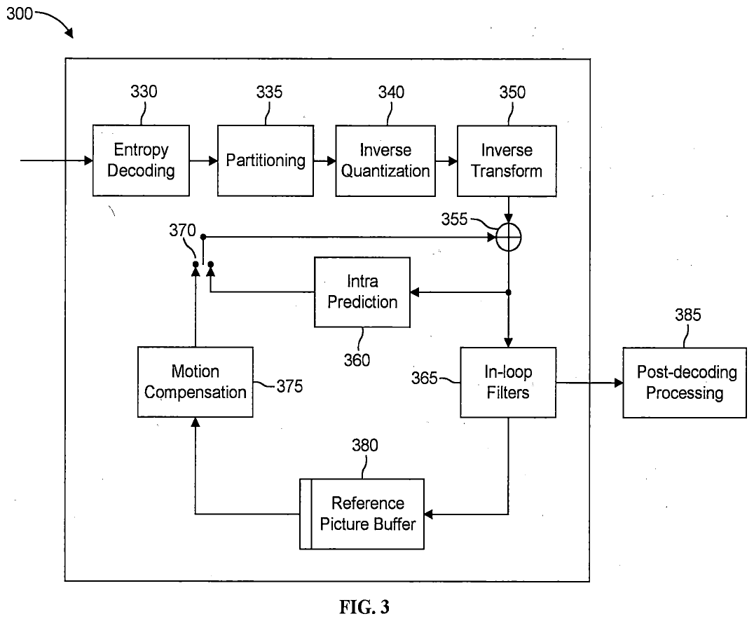

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2.

The encoder 200 also generally performs video decoding as part of encoding video data. In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

Intra prediction (260, 360) is used to remove correlation within local regions of a picture. The basic assumption for intra prediction is that texture of a current picture region is similar to the texture in a local neighborhood, e.g. picture blocks adjacent to the current region, and can thus be predicted from there. The direct neighbor samples are commonly employed for prediction, i.e. samples from the sample line above a current block to be encoded (decoded respectively) and samples from the last column of the reconstructed blocks to the left of the current block. The samples used for the prediction of a current block belong to a causal neighborhood, i.e. they are available (thus already reconstructed) when encoding or decoding the current block.

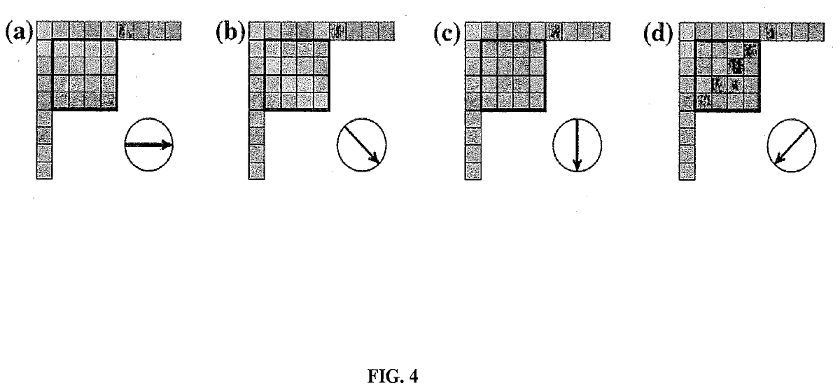

The reference neighbor samples which are used for predicting the current block depend on the direction indicated by the intra prediction angle of the respective intra prediction mode. An illustration of directional intra prediction with its reference neighbor samples is shown in FIG. 4. For example, for horizontal prediction (case (a)), the reference neighbor samples from the left column are directly used: for vertical prediction (case (c)), the reference neighbor samples from the above row are directly used: for diagonal down right prediction (case (b)), the reference neighbor samples from the above-left side are applied and for diagonal down left prediction (case (d)), the reference neighbor samples from the above-right side are applied. In the following sections, various tools for intra prediction in Exploratory Coding Model (ECM) are detailed.

Intra Mode Coding with 67 Intra Prediction Modes

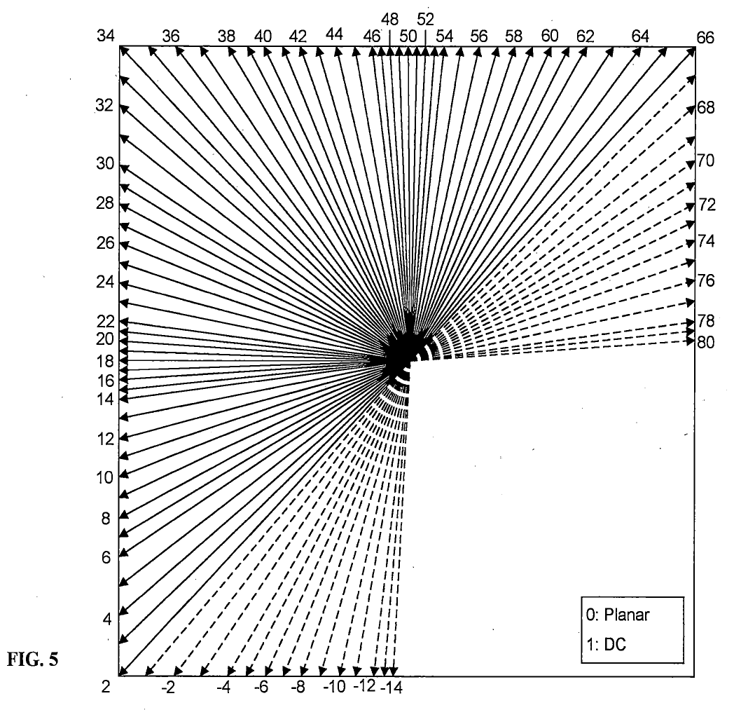

To capture the arbitrary edge directions present in natural video, the number of directional intra modes in Versatile Video Coding (VVC) and Exploratory Coding Model (ECM) is extended from 33, as used in High Efficiency Video Coding (HEVC), to 65, as depicted in FIG. 5, and the PLANAR and DC modes remain the same. These denser directional intra prediction modes apply for all block sizes and for both luma and chroma intra predictions.

For a square CU, only the conventional angular intra prediction modes 2-66 are used. These prediction modes correspond to angular intra prediction directions that are defined from 45 degrees to −135 degrees in clockwise direction.

In VVC, several conventional angular intra prediction modes are adaptively replaced with Wide Angle Intra Prediction Modes (WAIP) for non-square blocks. As dotted arrows shown in FIG. 5, the wide angular modes beyond the bottom-left direction modes are indexed from −14 to −1, the wide angular modes beyond the top-right direction are indexed from 67 to 80. For some flat blocks (W>H) and tall blocks (W<H), they use wide angular modes to replace equal number of regular angular modes in the opposite direction.

### Matrix Weighted Intra Prediction (MIP)

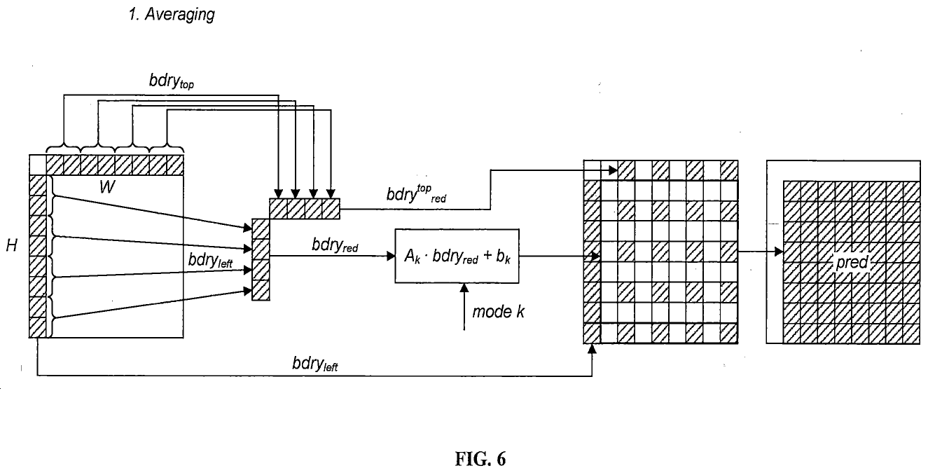

Matrix Weighted Intra Prediction (MIP) method is a newly added intra prediction technique into VVC. For predicting the samples of a rectangular block of width W and height H, MIP takes one line of H reconstructed neighboring boundary samples left of the block and one line of W reconstructed neighboring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 6.

For each intra-coded block, a flag mip_flag indicating whether a MIP mode is to be applied or not is signaled.

Decoder side intra mode derivation (DIMD)

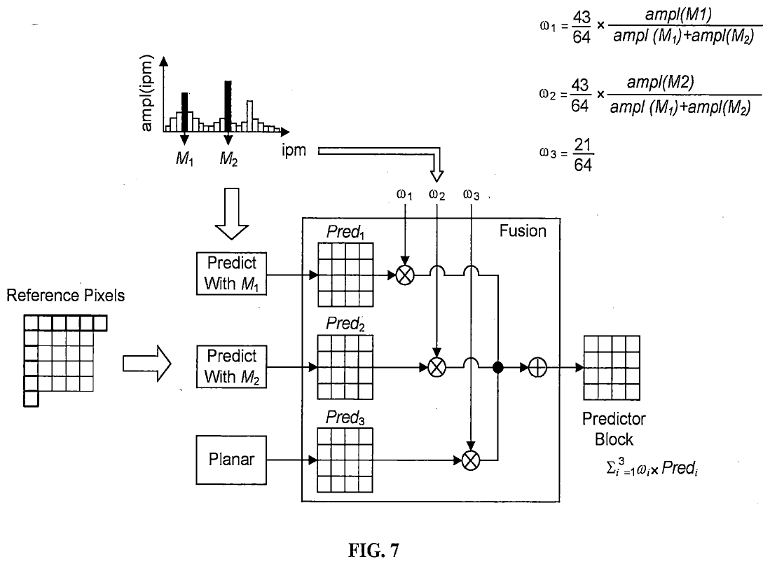

In ECM, Decoder side Intra Mode Derivation (DIMD) is also newly added to derive the intra mode used to code a CU. When DIMD is applied, two intra prediction modes M1 and M2 that are likely the two best intra prediction modes for predicting the current CU, are derived from a Histogram of Oriented Gradients (HOG) computed from the neighboring pixels of current block. Those two predictors are combined with the planar mode predictor with the weights ω₁ and ω₂ derived from the HOG in this template, as illustrated in FIG. 7.

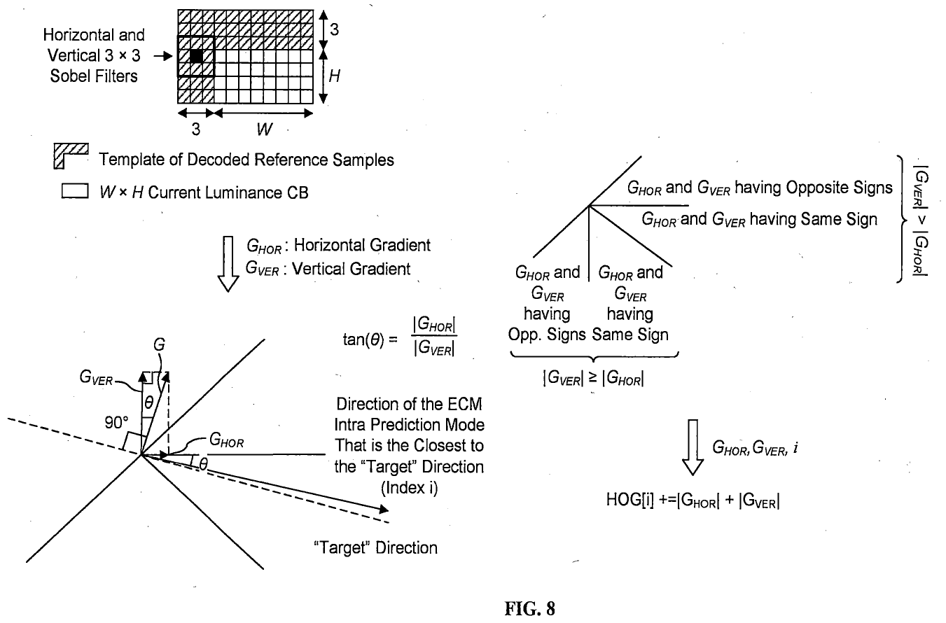

More precisely, for the current CU, the two intra prediction modes are derived from the gradients in this template as depicted in FIG. 8. Firstly, a HOG with 65 bins, corresponding to the 65 directional intra prediction modes, are initialized to 0. Then, for each decoded reference sample in the middle row or the middle column of the template of three rows of decoded reference samples above the current CU and three columns of decoded reference samples on its left side, the following procedure applies:
A 3×3 horizontal Sobel filter and a 3×3 vertical Sobel filter, both centered at this decoded reference sample, yield a horizontal gradient G_{HOR} and a vertical gradient G_{VER} respectively.
The signs of G_{HOR} and G_{VER} indicate in which of the four ranges of directions is found the “target” direction being perpendicular to the gradient G of horizontal component G_{HOR} and vertical component G_{VER}. If |G_{VER}|>|G_{HOR}|, the anchor direction corresponds to the horizontal direction. If |G_{HOR}|≥|G_{VER}|, the anchor direction corresponds to the vertical direction. The “target” direction forms an angle θ with respect to the anchor direction.
By discretizing a scaled version of tan(θ), the index i of the intra prediction mode whose direction is the closest to the “target” direction is found.
The HOG bin of index i is incremented by |G_{HOR}|+|G_{VER}|.

Finally, the indices of the two largest HOG bins are the indices of the two derived intra prediction modes M1 and M2.

For each intra-coded block, a flag namely dimd_flag indicating whether a DIMD mode is to be applied or not is signaled

### Fusion for Template-Based Intra Mode Derivation (TIMD)

In ECM, the intra mode used to code a CU derived using the Fusion for Template-based Intra Mode Derivation (TIMD) is newly introduced, and the process is described below.

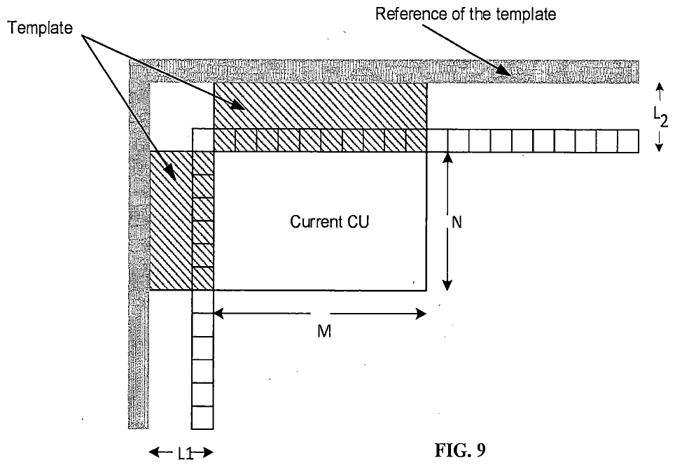

For each intra prediction mode in most probable modes (MPMs) list, the Sum of Absolute Transformed Differences (SATD) between the prediction and reconstruction samples of the template is calculated as depicted in FIG. 9. On FIG. 9, the current CU is of size M×N and the template comprises left already reconstructed samples of size L1×N and above already reconstructed samples of size M×L2 respectively. The prediction of the template is obtained for each intra prediction mode from the reference samples located in the reference of the template (gray part on FIG. 9). First two intra prediction modes with the minimum SATD are selected. Note that, for TIMD, the set of directional intra prediction modes is extended from 65 to 129, by inserting a direction between each black solid arrow in FIG. 5. This means that the set of possible intra prediction modes derived via TIMD gathers 131 modes. After retaining two intra prediction modes from the first pass of tests involving the MPM list supplemented with default modes, for each of these two modes, if this intra prediction mode is neither PLANAR nor DC, TIMD also tests in terms of prediction SATD its two closest extended directional intra prediction modes. On condition that SATD_{IPM2}<2*SATD_{IPM1} is true, these final two selected intra prediction modes are fused with the weights, which are dependent on the SATDs of the two intra prediction modes: otherwise, only the first intra prediction mode is used.

For each intra-coded block, a flag namely timd_flag indicating whether a TIMD mode is to be applied or not is signaled.

### Multiple Reference Line (MRL)

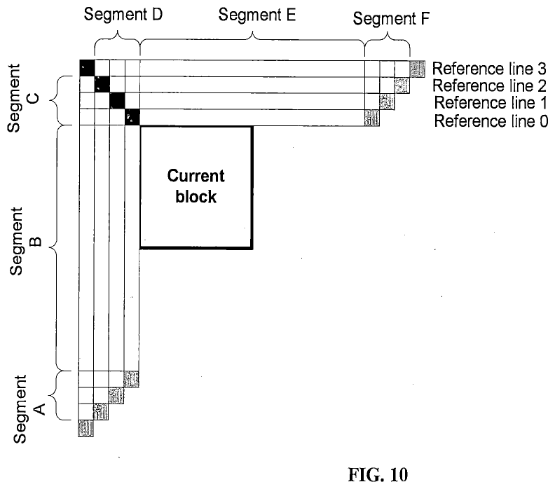

In VVC and ECM, Multiple reference line (MRL) intra prediction uses more reference lines for intra prediction. MRL prediction mode is motivated by the observation that non-adjacent reference lines are mainly beneficial for texture patterns with sharp and strongly directed edges. If texture patterns are smooth, MRL prediction mode is expected to be less useful in this case. In FIG. 10, an example of 4 reference lines is depicted, where the samples of segments A and F are not fetched from reconstructed neighboring samples but padded with the closest samples from Segment B and E, respectively. HEVC intra-picture prediction uses the nearest reference line (i.e., reference line 0). For example, inVVC, MRL intra prediction uses 2 additional lines (reference line 1 and reference line 2).

The index of selected reference line mrl_idx is signaled and used to generate intra predictor.

### Intra Sub Partition (ISP)

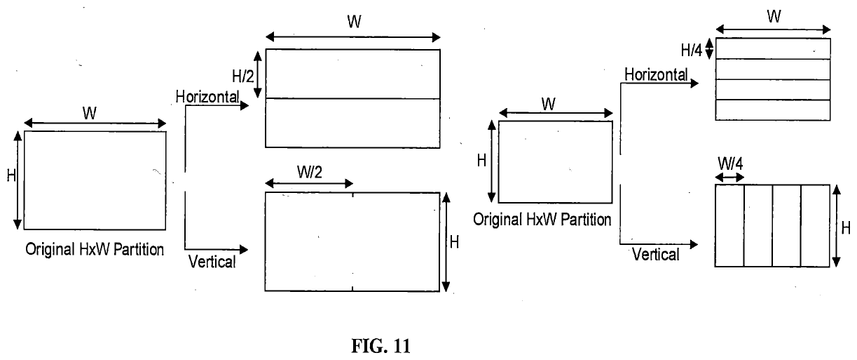

The intra sub-partitions (ISP) is introduced in VVC and ECM to divide luma intra-predicted blocks vertically or horizontally into 2 or 4 sub-partitions depending on the block size. FIG. 11 shows examples of the two possibilities. The reconstructed sample values of each sub-partition are available to generate the prediction of the next sub-partition, and each sub-partition is processed independently in a sequential order. All sub-partitions fulfill the condition of having at least 16 samples, also share the same intra mode.

For each intra-coded block, a flag namely isp_flag indicating whether an ISP is to be applied or not is signaled. Another syntax namely isp_mode to specify the split vertically or horizontally is further signaled on condition that isp_flag is true.

### Spatial Geometric Partitioning Mode (SGPM)

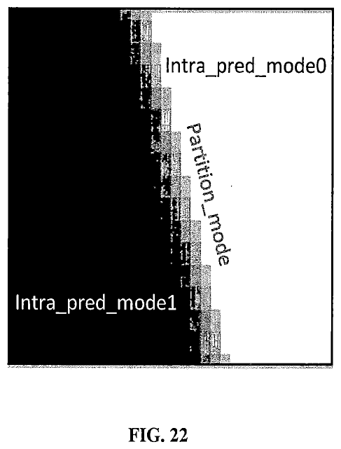

The spatial geometric partitioning mode (SGPM) is a new intra-coding tool, introduced in ECM, which partitions a coding block into two parts and generates two corresponding intra-prediction modes. FIG. 22 shows an example of a SGPM block partitioned according to one partition mode into two parts, each part being associated with an intra prediction mode. In an example, 26 predefined partition modes are used. For each partition mode, an intra prediction mode (IPM) list is derived for each part. The IPM list size is 3. Each possible combination of one partition mode and two intra prediction modes of the IPM list is considered as a SGPM candidate, and only the candidate index that is effectively used for coding is signaled in the bit-stream. A template is used to generate this candidate list. Both encoder and decoder construct the same candidate list based on the template.

For each intra-coded block, a flag namely sgpm_flag indicating whether a SGPM is to be applied or not is signaled. On condition that sgpm_flag is true, another syntax namely sgpm_cand_idx is further signaled in order to specify which combination of one partition mode and two intra prediction modes is used, i.e. which SGPM candidate of the candidate list is used for coding.

### Intra Prediction Mode Signaling in ECM

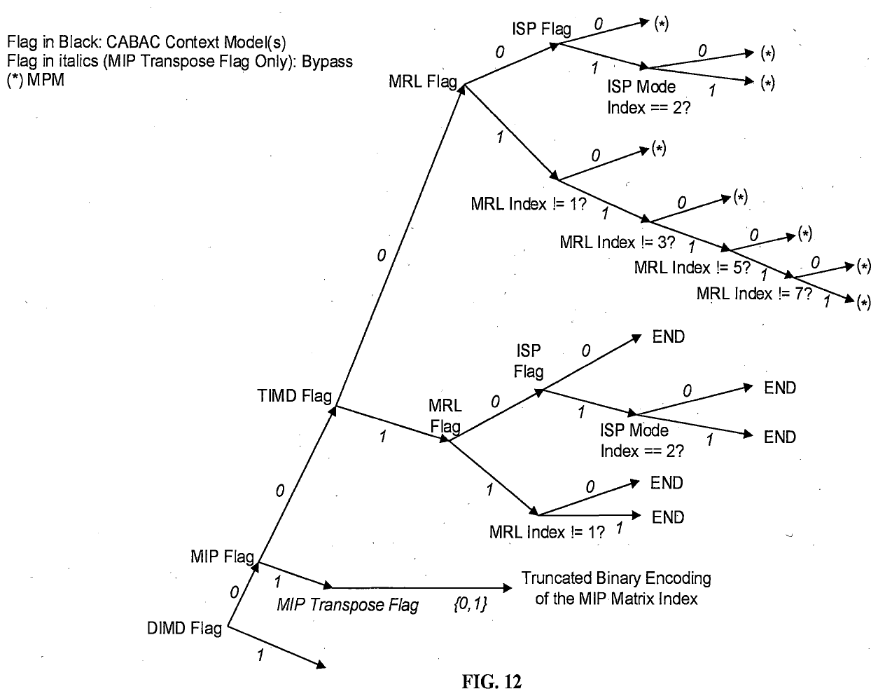

The signaling of the intra prediction mode selected to predict the current CU in ECM-5.0 is illustrated on FIG. 12 where the syntax elements associated with DIMD, MIP, TIMD, MRL, ISP and conventional intra prediction modes (PLANAR, DC and angular intra prediction modes) are illustrated. Note that FIG. 12 describes the signaling of the intra prediction mode selected to predict the current CU on the encoder side, but the same applies on the decoder side.

Also note that, Block Differential Pulse Coded Modulation (BDPCM), Template-based Intra Prediction (TMP), Intra Block Copy (IBC), and Palette are ignored as these tools are activated for specific video sequences, e.g. screen content.

As shown in FIG. 12, the flag indicating whether DIMD mode (see Section entitled “Decoder side intra mode derivation (DIMD)”) is applied, i.e., dimd_flag, is signaled first. If DIMD is signaled as not being applied, the flag indicating whether MIP mode (see Section entitled “Matrix weighted Intra Prediction (MIP)”) is applied, i.e., mip_flag, is signaled next. For the coding of MIP modes, two separate syntax elements are signaled. First, a flag mip_transpose_flag is signaled that determines whether the transposed MIP mode is to be used or not. Second, an index mip_mode is signaled that specifies which MIP mode is to be applied. The index mip_mode is signaled using a truncated binary code. If MIP is not applied, the flag indicating whether TIMD mode (see Section entitled “Fusion for template based intra derivation mode (TIMD)”) is applied, i.e., timd_flag, is signaled subsequently. If MIP is signaled as not being applied, the index mrl_index is signaled that indicates which reference line is to be used. If the adjacent reference line is applied, i.e., if mrl_index is 0, then the flag isp flag indicating whether ISP is applied is signaled. When isp_flag is signaled as true, an additional syntax element isp_mode that indicates whether horizontal or vertical splitting is applied for ISP mode is signaled.

In current ECM-5.0, if the intra prediction mode selected to predict the current CU is neither DIMD, nor a MIP mode, nor TIMD, i.e. it is one of the conventional 67 intra prediction modes mentioned in Section entitled “Intra mode coding with 67 intra prediction modes”, a Most Probable Mode (MPM) list-based signaling scheme is defined to efficiently code this slected mode with less signaling overhead. In ECM-5.0, the generic MPM list is decomposed into a list of 6 primary MPMs (PMPM) and a list of 16 secondary MPMs (SMPM).

A first flag mpm_flag specifies whether a PMPM list is being used. If the mpm_flag is signaled as 1, an index mpm_index, using a truncated unary code with 1 to 5 bits, is signaled to identify which of the six PMPMs, defined below, is applied. Specifically, mpm_index code words of various lengths are used as shown in the Table 1.

TABLE 1
Binarization for the MPM index using a truncated
unary code mpm_index is an index of a mode
in the PMPM list that comprises 6 entries in ECM.

| mpm_index | Truncated Unary |
|---|---|
| 0 | 0 |
| 1 | 10 |
| 2 | 110 |
| 3 | 1110 |
| 4 | 11110 |
| 5 | 11111 |

If the mpm_flag is signaled as 0, another flag smpm_flag specifies whether a SMPM list is being used is signaled. If the smpm_flag is signaled as 1, an index smpm_index, using a 4-bit fixed length code, is signaled to identify which of the sixteen SMPMs, defined below, is applied. If the smpm_flag is signaled as 0, an index non_mpm_index is signaled using truncated binary code with 5 to 6 bits to indicate which of the remaining 45 non-MPM modes is applied. More precisely, each non-MPM index of the first 19 modes uses 5 bits for signaling, and each of the remaining 26 non-MPM modes uses 6 bits.

### Most Probable Mode (MPM) List in ECM

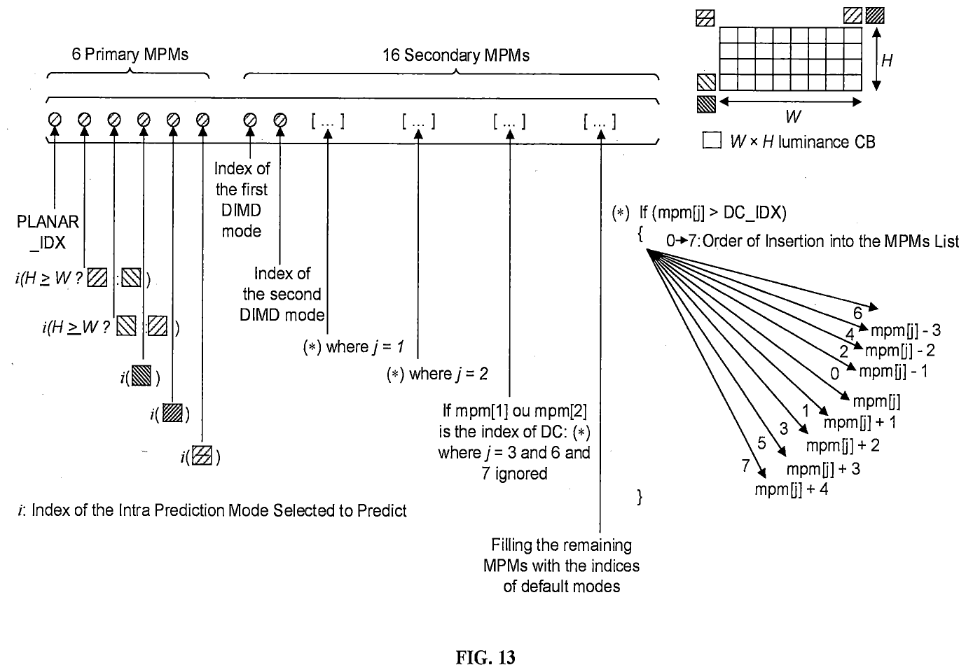

The method of MPM list-based signaling, which is employed in VVC and HEVC, is extended in ECM, where two MPM lists are generated instead of one: a primary MPM list and a secondary MPM list. The primary MPM (PMPM) list contains 6 entries, while the secondary MPM (SMPM) list contains 16 entries. A generic MPM list with 22 entries is thus built by sequentially adding (i.e. inserting or placing) candidate intra prediction mode indices, from the one most likely to be selected for predicting the current CU to the least likely one, as depicted in FIG. 13.

The first entry is normally the Planar mode as depicted on FIG. 13. Said otherwise, the Planar mode is first added (i.e. inserted or placed) to the generic list of MPMs. In some specific case. Planar mode is not added. Indeed, it has been observed that MRL does not provide additional coding gain when the intra prediction mode is the Planar mode, since this mode is typically used for smooth areas. Hence, if mrl_index is not 0, the Planar mode is excluded as the first MPM entry, also in this specific case, the entries filled in SMPM are not used.

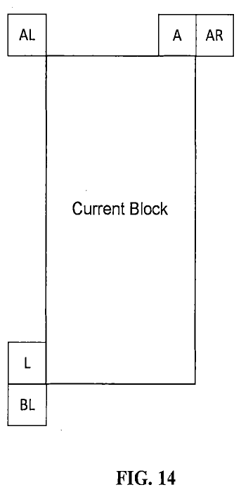

In the general case depicted on FIG. 13, the remaining entries are obtained from the intra modes of the above (A), left (L), below-left (BL), above-right (AR), and above-left (AL) neighboring blocks in sequential order. These neighboring blocks are adjacent to the current block. Below-left (BL) is also called bottom-left. The locations of neighboring blocks are shown in FIG. 14. The order to insert intra modes of neighboring blocks into MPM list is built starting from the above neighbor intra mode, however if rectangular block is horizontal oriented, i.e. when width is greater than height, the order to insert above and left neighboring intra modes is swapped. In ECM, if there are some empty entries after adding those spatial neighboring intra prediction modes candidates, two directional modes generated by DIMD may be inserted to the PMPM list. If the PMPM list is still not full, derived modes and predefined default modes may also be inserted in the end until the PMPM list is fulfilled. In the case where there is no empty entry after the insertion of those spatial neighboring intra prediction modes candidates, i.e. the PMPM list is fulfilled, the DIMD modes, derived modes and default modes may be added to the secondary MPM list as depicted on FIG. 13.

DIMD may thus be used for MPM list generation. Specifically. DIMD generates two directional modes (in addition to planar mode) of the current coding block which may be added to the generic MPM list. Besides, the directional modes with added offset (±1, ±2, ±3, ±4) obtained from the first two available directional modes (of indices mpm[1] and mpm[2] respectively) of neighboring blocks (called “derived modes”) may be added to the generic MPM list. Said otherwise, the 8 neighboring (in the sense of the directions) directional modes of each of the first two available directional modes are added to the generic MPM list. More precisely, in the example depicted on FIG. 13, the secondary MPM list is constructed by first adding the indices of the first and second DIMD modes of the current coding block, then adding incremented and decremented indices of the first two available directional modes in the MPM list (mpm[1]+1, mpm[1]−1, mpm[1]+2, mpm[1]−2, mpm[1]+3, mpm[1]−3, mpm[1]+4,mpm[1]−4, mpm[2]+1, mpm[2]−1, mpm[2|]+2, mpm[2]−2, mpm[2]+3, mpm[2]−3, mpm[2]+4, mpm[2]−4). Said otherwise, the directions of these derived modes are neighboring the directions of the modes of indices mpm[ 1] and mpm[2] as illustrated on bottom-right of FIG. 13. If either mpm[ 1] or mpm[2] is equal to DC intra mode, then mpm[3] may be used to obtain derived modes as illustrated on FIG. 13, mpm[i] is the index among the 67 intra prediction indices of the mode at the position i in the PMPM list and is thus different from mpm_index which is the index i in the PMPM list.

Additionally, some predefined default modes may also added into the list. The default mode list is defined as follows in ECM: {DC_IDX, VER_IDX, HOR_IDX, VER_IDX−4, VER_IDX+4, 14, 22, 42, 58, 10, 26, 38, 62, 6, 30, 34, 66, 2, 48, 52, 16}. In ECM, DC_IDX=1, VER_IDX=50 and HOR_IDX=18. HOR stands for Horizontal, VER for Vertical and IDX for index.

FIG. 13 depicts only an example. Indeed, if the PMPM list is not fulfilled by the intra modes of neighboring blocks, the DIMD modes, derived modes and default modes may be added to the primary MPM list until it is fulfilled instead of the SMPM.

Note that no redundancy exists in the generic list of MPMs, meaning that it does not contain two identical intra prediction mode indices. For example, suppose the slots of indices O to i−1 included in the generic list of MPMs have already been filled. If the current candidate intra prediction mode index already exists in the current generic list of MPMs, this candidate is skipped, and the next candidate intra prediction mode will be inserted at the slot of index i if it does not exist in the generic list of MPMs. Otherwise, the current intra prediction mode index is inserted at the slot of index i and the next candidate intra prediction mode will be inserted at the slot of index i+1 if it does not exist in the generic list of MPMs.

The intra prediction is a useful coding tool in hybrid video coding. For a given block to be predicted, the encoder selects an intra mode, e.g. a best mode in terms of rate-distortion, and signals its index to the decoder so that, for this block, the decoder can perform the same prediction. The increased number of intra prediction modes in VVC and ECM significantly improves the compression efficiency. However, this improvement comes with an extra cost of signaling the intra prediction mode index and reduces the gain from the intra part. Therefore, a smart way of coding the index of the intra prediction mode selected to predict a given block is to create a set of MPMs and thus reduce the signaling overhead if the index of the selected mode belongs to that list.

As described above, the method of MPM list-based signaling in ECM derives 6 PMPMs and 16 SMPMs from an ordered candidate list. This method suffers from the following limitations. First, the current MPM list is composed of semi-fixed ordering with a fixed size for different contents, which is quite inflexible. The only flexibility in ordering comes from the priority of left and above neighboring blocks based on the block shape (such as H being larger or lower than W). Second, intra modes of neighboring blocks generally play a dominant role in the MPM list construction. However, neighboring modes inserted from the semi-fixed ordering aforementioned above may not always be the most efficient modes for coding. It is expected that there exist different orderings or sizes of candidate list in the current MPM design that are more adapted to different cases.

In ECM, an index mpm index is signaled to identify which of the 6 PMPMs is applied. It uses a truncated unary code with various lengths from 1 to 5 bits, as shown in the Table 1. For a square block, if the intra prediction mode from the above neighboring block is selected, then the length of mpm index could just be 2-bit long while if the intra prediction mode from the above-left neighboring block is chosen, then 5 bits are used to signal the mpm index. Therefore, if the preferable intra prediction mode can be predicted, the bits consumed for representing the selected mode index can be economized, leading to better compression performance. As such, a mode with higher probability to be chosen could be inserted in the first entries of the PMPM list.

Besides, since the current SMPM uses a 4-bit fixed length code, if the size of the SMPM list could be shortened for some cases, the bits consumed for representing the selected mode index can also be economized. As such, a shorter SMPM size could be used for smaller block sizes.

Therefore, improving the design of the MPM list may thus be advantageous. The MPM list may thus be dynamically adapted by ordering the intra prediction modes in primary MPM (PMPM) list by counting the number of appearances/occurrences of at least some of the intra prediction modes, using different possible intra modes candidates than the predefined five spatial neighboring blocks to generate the PMPM list, inserting two derived DIMD intra modes before intra modes from the spatial neighboring blocks in the MPM list, and reuse them for ordering these spatial neighboring intra modes, adapting the offset range and/or the directional mode candidate for the derived modes to the block size and/or the (multi-type) tree depth, defining separate default mode list for square and non-square blocks and/or adapting the size of the PMPM list, secondary MPM (SMPM) list, and non-MPM list to the block size and/or the (multi-type) tree depth

In the following embodiments, most probable mode (MPM) list is thus improved by including dynamic derivation of intra prediction modes and by rendering its size dynamic. Besides, dynamic size for non-MPM list is also proposed. Therefore, the compression efficiency is improved, i.e. the bitrate is reduced while maintaining the quality, or equivalently the quality is improved while maintaining the bitrate.

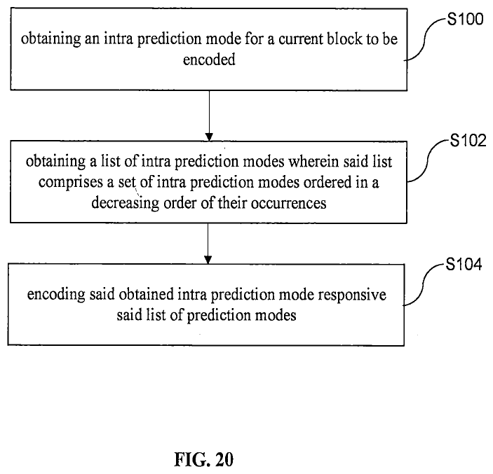

FIG. 20 depicts a flowchart of an encoding method according to an embodiment.

In a step S100, an intra prediction mode is obtained for a current block to be encoded. For example, the intra prediction mode is obtained based on a rate-distortion criterion. The encoding method is not limited by the method used to obtain this intra prediction mode for the current block.

In a step S102, a list of intra prediction modes, more precisely a list of MPMs, is obtained for said current block. The list comprises a set of intra prediction modes ordered as a function of their occurrences (e.g., according to how frequently each intra prediction mode occurs). In an example, the intra prediction modes of the set are ordered in decreasing order of their occurrences. Thus, the mode with the highest occurrence is listed/placed first in the list while a mode with the lowest occurrence is listed/placed at the end of the list.

To sort the intra prediction modes of the set in the PMPM list the number of appearances (i.e. occurrence) of the intra prediction modes is counted. An intra mode with higher appearance/occurrence count is considered to be “popular” in the PMPM list, i.e., it has a higher prior probability, and would thus be placed/listed at the beginning of the list.

In an embodiment, the set of intra prediction modes ordered as a decreasing order of their occurrences is a set of intra prediction modes of neighboring blocks of the current block. In an embodiment, the set of intra prediction modes of neighboring blocks of the current block comprises at least two intra prediction modes associated with one same neighboring block.

In a specific embodiment, the number of appearances/occurrences of only the intra prediction modes from the neighboring blocks, e.g. from the predefined five neighboring blocks, is counted. Thus, only these intra prediction modes are ordered in the list in a decreasing order of their occurrences while the order of remaining modes keeps unchanged. In a case where two intra prediction modes of neighboring blocks are of equal occurrence, the method comprises ordering said two intra prediction modes responsive to spatial positions of the neighboring blocks with respect to the current block.

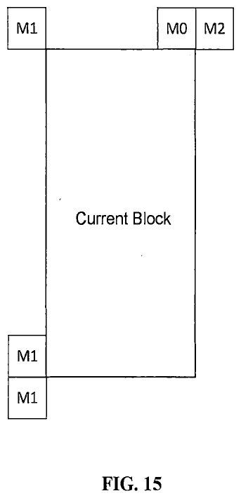

For example, for a vertical-oriented rectangular block (height is greater than width) shown in FIG. 15, mode M1 (from L, BL, AL) has a frequency of 3 (i.e. number of appearances/occurrences=3), and other two intra modes (mode MO from A and mode M2 from AR) only have the frequency of 1 (i.e. number of appearances/occurrences=1). Consequently. mode MI is inserted in the PMPM list in advance of mode M0. When there are more than one intra modes having the same appearance frequency, a derivation order (for square and vertical-oriented rectangular block: from A, L, BL, AR, to AL; for horizontal-oriented rectangular block: from L, A, BL, AR, to AL) is used to give a priority to some blocks in order to break the tie. In the previous example, mode M0 has the same appearance frequency as mode M2. Mode M0 from A is inserted in the PMPM list ahead of mode M2 from AR since A is before AR in the derivation order.

In another variant, the sorting priority could be different than the one specified by the current derivation order. Moreover, the sorting priority could be dependent on the block shape, meaning different design may be used for square, horizontal-oriented and vertical-oriented rectangular blocks. For example, if the rectangular block is horizontal oriented, i.e. when width is greater than height, the sorting priority could start from the left neighboring blocks: from L, AL, BL, A to AR: otherwise, the sorting priority swaps by beginning with the above neighboring blocks: from A, AL, AR, L to BL. The sorting priority is useful when two candidate modes have an equal occurrence to decide which one to insert first in the list.

In one variant, Planar mode is inserted as the first entry of the PMPM list, thus before the ordered intra prediction modes from the neighboring blocks. In one variant, except when MRL is applied, Planar mode is inserted as the first entry of the PMPM list, thus before the intra prediction modes from the neighboring blocks. In one variant, the two directional modes generated by DIMD are inserted before the spatial neighboring intra prediction modes ordered according to their occurrences. In another variant, the two directional modes generated by DIMD are inserted after the spatial neighboring intra prediction modes ordered according to their occurrences. In another variant, the derived modes may also be added to the list. The list of intra prediction modes may thus comprise, after the set of intra prediction modes of neighboring blocks, at least one intra prediction mode whose direction is close to a direction of at least one of the two intra prediction modes with highest occurrences. The at least one intra prediction mode whose direction is close to the direction of at least one of the two intra prediction modes with highest occurrences is determined by incrementing and decrementing, by an offset, an index of the at least one of the two intra prediction modes with highest occurrences, wherein a range of said offset depends on a size of the current block and/or on a tree depth of the current block. In this case, the derived modes may be directional modes with added offset (±1, ±2, ±3, ±4) from the first two directional modes with higher appearance count, rather than the first two available directional modes of neighboring blocks. In another embodiment, the list of intra prediction modes comprises, after the set of intra prediction modes of neighboring blocks, at least one intra prediction mode of another ordered list of default intra prediction modes whose order depends on a shape of the current block. The size of the lists (e.g. PMPM, SMPM, non-MPM lists) may depend on a size and/or tree-depth of the current block.

In a step S104, the obtained intra prediction mode is encoded responsive to said list of prediction modes. More precisely, an index of the obtained intra prediction mode is encoded by a binary code, e.g. in a bitstream, associated with the position of this intra mode in the ordered list. As an example, if the intra prediction mode obtained at step S100 is the third mode of the obtained list, i.e. the mode of mpm_index=2, then the truncated unary code “110” is used to encode it as mentioned in Table 1. The principles of primary MPM, secondary MPM, non-MPM list and their associated syntax (flags) as defined previously may be used in combination with the current embodiment. Said otherwise, in one embodiment the ordering of the modes based on their occurrences is different from the ordering of the modes in ECM-5.0, however, the other encoding principles (intra prediction signaling of ECM) may be the same. The prediction residue of the block is also encoded.

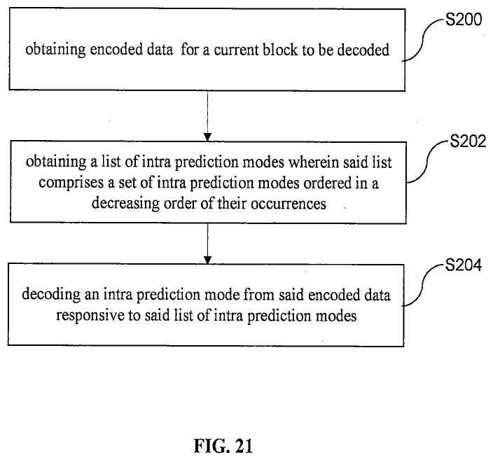

FIG. 21 depicts a flowchart of a decoding method according to an embodiment.

In a step S200, encoded data are obtained for a current block to be decoded. The encoded data may be obtained from a bitstream generated by an encoding method such as the one illustrated on FIG. 20. The encoded data comprises syntax elements representative of the current block.

In a step S202, a list of prediction modes is obtained, more precisely a list of MPMs. The list comprises a set of intra prediction modes ordered as a function of their occurrences (e.g., according to how frequently each intra prediction mode occurs). In an example, the intra prediction modes of the set are ordered in decreasing order of their occurrences. Thus, the mode with the highest occurrence is listed/placed first in the list while a mode with the lowest occurrence is listed/placed at the end of the list. The list is obtained in the same way as on the encoding side. Said otherwise S202 is identical to S102. The various embodiments disclosed with respect to FIG. 20 also apply to decoding method.

In a step S204, an intra prediction mode is decoded from the encoded data obtained at step S200 responsive to the list of prediction modes obtained at step S202. More precisely, a binary code is obtained, e.g. from the encoded data, that correspond to said intra prediction mode. From the binary code and the obtained list of prediction modes an index is derived, said index is the index of the prediction mode associated with said current block to be decoded. As an example, if the binary code is “1110” of Table 1, the decoded intra prediction mode is the fourth mode of the obtained list. The principles of primary MPM, secondary MPM, non-MPM list as defined previously may be used in combination with the current embodiment. Said otherwise, in one embodiment the ordering of the modes based on their occurrences is different from the ordering of the modes in ECM-5.0. However, the other principles (notably the signaling) may be the same. The current block may then be decoded using the decoded intra prediction mode.

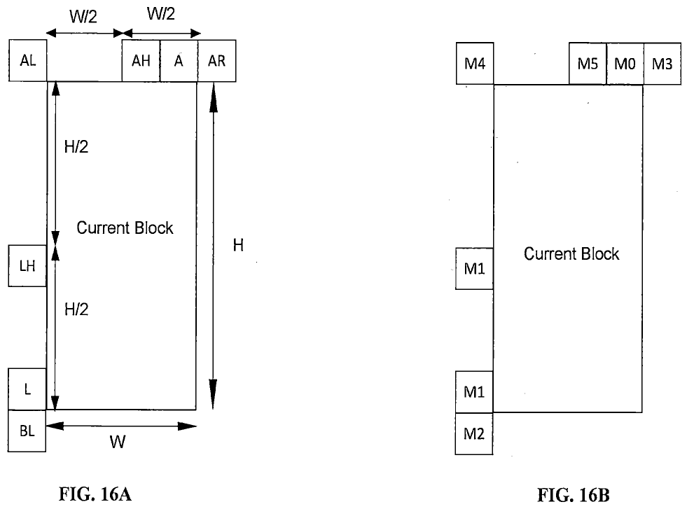

Further embodiments are disclosed below. They apply to both encoding and decoding methods. In the previous embodiments, the same five neighboring blocks as in ECM were considered; FIG. 16A and FIG. 16B illustrate examples of various embodiments, wherein more neighboring blocks are used for MPM list derivation at step S102 or S202. Said otherwise, in this embodiment the PMPM list could use different possible intra mode candidates than the modes of the predefined five neighboring blocks. In one variant of this embodiment depicted on FIG. 16A, the intra modes of one or two available spatial neighboring blocks, located at a half position of the current block size, e.g. at a half position of the height and/or of the width (respectively called LH and AH), are included for counting and sorting the PMPM list, in addition to the modes of the predefined five neighboring blocks depicted on FIG. 14. In one specific embodiment, the location of a neighboring block is determined by the location of one of its samples, e.g. its top right sample for LH and its bottom-left sample for AH. Therefore, on FIG. 16A, the LH block is located at the half position of the current block height. More precisely, the y-coordinate of top-right sample of the LH block is located at the half position of the current block height (y=½ height). The AH block is located at the half position of the current block width. More precisely, the x-coordinate of bottom-left sample of the AH block is located at the half position of the current block width (x=½ width). Said otherwise, the neighboring sample is located at a distance half of a height (−1, ½ height) or width (½ width, −1) of the current block.

The derivation order and the sorting priority could be from A, L, BL, AR, AL, AH to LH for a square or a vertical-oriented rectangular block, and from L, A, BL, AR, AL, LH to AH for a horizontal-oriented rectangular block. The sorting priority is useful when two candidate modes have the same appearance count to decide which one to insert first in the list. In the case where the length of PMPM list keeps unchanged and thus equal to six, some intra modes with lower appearance count or in the end of the derivation order may not be added to the list especially if there are more than non-identical six intra prediction modes. The embodiments may however be used with PMPM of length larger or lower than 6. For example, for a vertical-oriented rectangular block shown in FIG. 16B, mode MI (from L, LH) has the frequency of 2, and the remaining five intra modes (mode M0 from A, mode M2 from BL, mode M3 from AR, mode M4 from AL, and mode M5 from AH) only have the frequency of 1, mode M5 from AH is thus not inserted in the PMPM list. Indeed. AH is at the end of the derivation order.

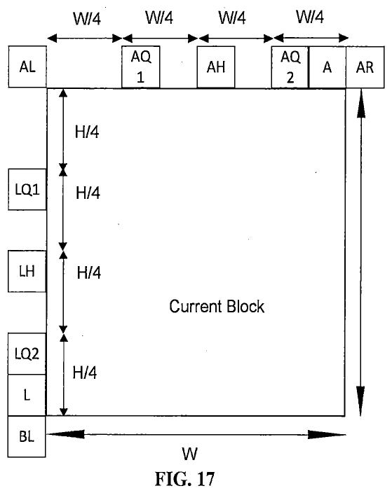

In another variant of this embodiment depicted on FIG. 17, the intra prediction modes of one or more of the six available spatial neighboring blocks, located at quarter positions (¼, ½and ¾) of the current block width and height (respectively called LQ1, LH, LQ2, AQ1, AH and AQ2), are included for counting and sorting the PMPM list, in addition to the intra prediction modes of the predefined five neighboring blocks. As for the above embodiment, in one specific embodiment, the location of a neighboring block is determined by the location of one of its samples, e.g. its top right sample for LH, LQ1 and LQ2 and its bottom-left sample for AH, AQI and AQ2. The derivation order and the sorting priority could be from A, L, BL, AR, AL, AH, LH, AQ1, LQ1, AQ2 and LQ2 for square and vertical-oriented rectangular block: and from L, A, BL, AR, AL, LH, AH, LQ1, AQ1, LQ2 and AQ2 for horizontal-oriented rectangular block.

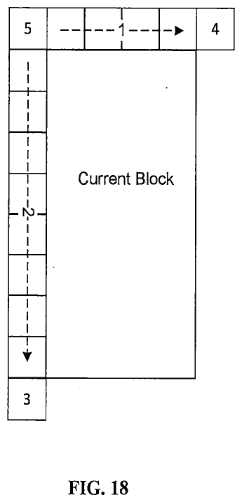

In yet another variant of this embodiment, intra prediction modes of a set of spatial neighboring blocks are included for counting and sorting the PMPM list. An example of a set of adjacent spatial neighboring blocks from above and left side of a vertical-oriented rectangular block is illustrated in FIG. 18, wherein each spatial neighboring block is a 4×4 block. For constructing the PMPM list, the derivation order and the sorting priority for a vertical-oriented rectangular block that is indicated by the numbers 1-5 in FIG. 18 is as follows: the above adjacent row from left to right (number 1 on FIG. 18); the left adjacent column from above to bottom (number 2 on FIG. 18): the bottom-left neighboring block (number 3 on FIG. 18): the above-right neighboring block (number 4 on FIG. 18): and finally the above-left block neighboring block (number 5 on FIG. 18).

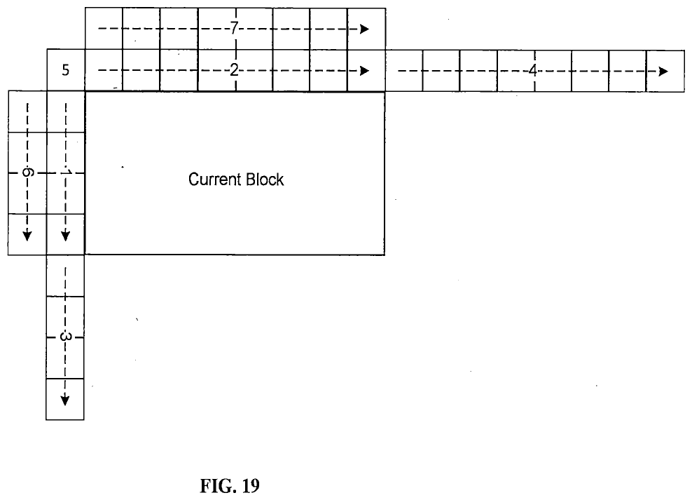

Another example for a horizontal-oriented rectangular block is shown in FIG. 19 with additional sets of adjacent neighboring blocks from above-right and bottom-left side and non-adjacent neighboring blocks from above and left side, which are close but not directly adjacent to the current block. The first six intra modes in the ranked order with higher appearance count will be used for the PMPM list. In the case where the PMPM list comprises more than 6 entries, e.g. X entries, then the first X intra modes in the ranked order with higher appearance count will be used for the PMPM list.

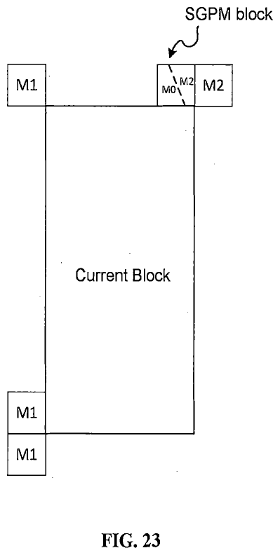

In another variant of this embodiment depicted on FIG. 23, if one of the available spatial neighboring blocks uses SGPM, two intra prediction modes from this SGPM neighboring block may be available, and thus may be included for counting and sorting the PMPM list. In the specific example of FIG. 23, the neighboring block located in above position A (as depicted on FIG. 14) is using SGPM, e.g. it consists of two intra prediction modes (mode M0 and mode M2). Mode M1 (from L, BL, AL) has a frequency of 3 (i.e. number of appearances/occurrences−3), and mode M2 from A and AR has a frequency of 2 (i.e. number of appearances/occurrences=2), the remaining intra mode (mode M0 from A) only has a frequency of 1 (i.e. number of appearances/occurrences=1). Consequently, mode M1 is inserted in the PMPM list first, and mode M2 is inserted in the PMPM list in advance of mode M1.

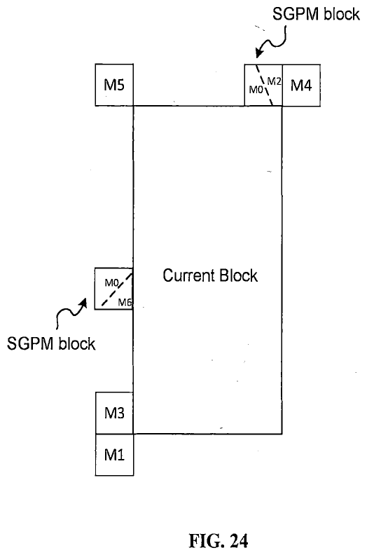

FIG. 24 depicts another embodiment wherein only 6 spatial neighboring blocks are considered but 7 intra modes are ordered, namely M1 to M6. In this example, mode MO is listed first in the PMPM list as it has a frequency of 2 while the other modes have a frequency of 1. All these available intra modes (M1 to M6) could be included to generate the PMPM list.

These embodiments may be extended to the case where more than one neighboring block uses SGPM. These embodiments may be extended to the case where a neighboring block is partitioned into more than two parts, each part being associated with its own intra prediction mode.

In another variant, only 2 neighboring blocks (above A and left L) are considered for the PMPM list generation when the block size is less than a specific number.

In another variant, different weights may be applied to each intra mode of a neighboring block. Statistically the intra modes from the immediate adjacent above and left neighboring blocks tend to have higher correlation with the current block than the other blocks, and hence are considered with higher weights. More precisely, instead of incrementing the appearance count by one, the appearance count may be incremented by more than one for the modes of these blocks having higher correlation with the current block. Moreover, the weights could be different for square, horizontal-oriented and vertical-oriented rectangular blocks. For example, if the rectangular block is horizontal oriented, higher weights are applied on intra modes from the left side neighboring blocks than the ones from the above side. As an example, with respect to the example of FIG. 16B, higher weights (e.g. weights equal to 3) may be given to the intra modes (M0, M3, M5) from the above side neighboring blocks than the ones from the left side (M1, M2 and M4). Said otherwise, at step S102 or S202. the number of appearances for MI may be set to 2 (considering a weight equal to 1), for M2 and M4 may be set to 1 (considering a weight equal to 1) and for M0, M3, M5 may be set to 3 (considering a weight equal to 3) in order to give them more priority for the ordering. Indeed, without the weighting, M0, M3 and M5 would have a number of appearances of 1 and would be placed after M1 in the list while with the weighting they would be placed in the list before M1.

Intra modes of neighboring blocks generally play dominant roles in the MPM list construction due to higher correlation with the current block. However, neighboring modes inserted from a semi-fixed ordering may not always be the ones with highest coding efficiency. When DIMD is applied, two intra prediction modes that are likely to be the two best intra prediction modes out of the 65 directional intra prediction modes for predicting the current CU. are derived from the gradients computed from the neighboring pixels of current block. These DIMD intra modes may be included into the MPM list. Currently, these two DIMD intra modes are added to MPM list after those intra modes from the spatial neighboring blocks. However, these two DIMD intra modes are directly generated by analyzing the local gradients with neighboring pixels, meanwhile the correlation between the current block and the intra modes from a semi-fixed ordering is based on large empirical results. In an embodiment, the two DIMD intra modes are inserted in the first entries of the MPM list, i.e. before those intra modes from the spatial neighboring blocks, in a case where DIMD is applied. In one variant, Planar mode is inserted as the first entry of the PMPM list, before these two derived DIMD intra modes. In one variant, except when MRL is applied. Planar mode is inserted as the first entry of the PMPM list, before these two DIMD intra modes. In another variant, in step S102 and S202, the intra prediction modes from the neighboring blocks, i.e. the five neighboring blocks or more than five as depicted on FIGS. 16A and 17-19, are ordered by calculating the absolute difference between their intra prediction mode indices (IPM) and those of the first derived DIMD intra mode (IPM_{DIMD1st}) and the second (IPM_{DIMD2nd}) instead of being ordered according to their occurrences. Therefore, the intra mode from the spatial neighboring block with closest direction to the derived DIMD intra modes could be inserted in the PMPM list firstly. More precisely. the absolute difference calculation of intra prediction mode indices could be combined with the weights derived from the DIMD gradients, such as w₁* |IPM−IPM_{DIMD1st}|+w₂*|IPM−IPM_{DIMD2nd}|. where w₁ represents the weight for the first DIMD intra mode, and w₂ represents for the second one.

In another embodiment. the list of derived modes is rendered dynamic in the MPM list generation. i.e. is adapted to the block size and/or the (multi-type) tree depth of the current block to be encoded/decoded. In one example of a quadtree with nested multi-type tree coding tree structure, the multi-type tree depth is the hierarchy depth of multi-type tree splitting from a quadtree root node. Therefore, if the quadtree leaf node is also the root node for the multi-type tree then it has multi-type tree depth of 0 and if the quadtree root node is further horizontal binary splitting into 2 parts then it has multi-type tree depth of 1. Indeed, the small blocks do not justify the searching cost of the additional granularity, meaning that the offset range and/or the directional mode candidate for the derived modes could be adapted to the block size and/or the (multi-type) tree depth. In one variant, in a case where the current block size of the current block, e.g. width and/or height, is less than a specific number, narrower offset range could be applied for derived modes of this block, and vice versa. For example, if block size is smaller than 8×8 then the derived modes could be directional modes with added offset (±1) from the first two directional modes in the list, e.g. from the first two directional modes with higher occurrence. In another variant, in a case where the block size, e.g., width and/or height of the current block is less than a specific number, fewer directional mode candidates could be applied for derived modes of this block, and vice versa. For example, if block size is smaller than 8×8 then the derived modes could be directional modes with added offset (±1, ±2, ±3, ±4) from only the first directional mode of the list, e.g. from the directional mode with higher occurrence. These two variants could be combined for adapting the derived modes to the block size.

In another variant, when the (multi-type) tree depth of the current block is larger than a specific number, narrower offset range and/or fewer directional mode candidate could be applied for derived modes of this block, and vice versa. For example, if the (multi-type) tree depth is 2, the derived modes could be directional modes with added offset (±1, ±2) from only the first one directional mode, e.g. from the directional mode with higher occurrence.

In another embodiment, the list of default modes in the MPM list generation is rendered dynamic, i.e. is adapted to the block shape of the current block to be encoded/decoded. Specifically, the default mode list could be defined separately for square and non-square blocks. The prior-art default mode list is defined as follows {DC_IDX, VER_IDX, HOR_IDX, VER_IDX−4, VER_IDX+4, 14, 22, 42, 58, 10, 26, 38, 62, 6, 30, 34, 66, 2, 48, 52, 16}. In one variant, vertical intra modes could be inserted first in the default mode list for horizontal-oriented rectangular blocks, and horizontal intra modes could be inserted first in the default mode list for vertical-oriented rectangular blocks. For example, the default mode list for horizontal-oriented rectangular blocks could be defined as follows {DC_IDX, VER_IDX, VER_IDX-4, VER_IDX+4, 42. 58, 38, 62, 34, 66, 48, 52, HOR_IDX,14, 22, 10, 26, 6, 30, 2, 16}; and another default mode list for vertical-oriented rectangular blocks could be defined differently as follows {DC_IDX, HOR_IDX,14, 22, 10, 26, 6, 30, 2, 16, VER_IDX, VER_IDX−4, VER_IDX+4, 42, 58, 38, 62. 34, 66, 48, 52}. In another variant, horizontal intra modes could be excluded from the default mode list for horizontal-oriented rectangular blocks, and vice versa. For example, the default mode list for horizontal-oriented rectangular blocks could be defined as follows {DC_IDX, VER_IDX, VER_IDX−4, VER_IDX+4, 42, 58. 38, 62. 34,66. 48, 52} and the default mode list for vertical-oriented rectangular blocks could be defined as follows {DC_IDX, HOR_IDX, HOR_IDX-4, HOR_IDX+4, 10, 26, 6, 30, 2, 16}.

In an embodiment, the size of the PMPM list is rendered dynamic, i.e. the size is for example adapted based on the block size and/or the (multi-type) tree depth of the current block to be encoded/decoded. Specifically, a current block with a small number of pixels to be predicted does not justify the signaling cost of the additional granularity, meaning that the size of the PMPM list could be adapted to the block size and/or the (multi-type) tree depth. For example, in a case where the block size, e.g., width and/or height, of the current block is less than a specific number, smaller PMPM list size would be applied for this block, and vice versa. For example, if block size is smaller than 8×then the corresponding PMPM list size may be set to M=3. This could save up to 3 bins with the truncated unary code. In one variant, the number N of intra prediction mode candidates from spatial neighboring blocks could be larger than the PMPM list size, meaning that it can discard N−M intra modes with lower appearance count or in the end of the derivation order.

In ECM-5.0, if PMPM list is not being used, the mpm_flag is signaled as 0), and another flag smpm_flag specifying whether a secondary MPM (SMPM) list is being used is signaled. The SMPM list is filled with 16 entries, and it uses a 4-bit fixed length code. Again, a block with small number of pixels to be predicted does not justify the signaling cost of the additional granularity. If the SMPM list size is reduced from 16 entries to 8 entries, then the length of SMPM index mpm index could just be 3-bit long, i.e. I bit is saved. Therefore, if the SMPM list can be shortened or even removed under some situations, the bits consumed for representing the selected mode index can be economized. Therefore, in an embodiment, the size of the SMPM list is rendered dynamic, i.e. the size is for example adapted based on the block size and/or the (multi-type) tree depth of the current block to be encoded/decoded. For example, in case where the block size, e.g., width and/or height, of the current block is less than a specific number, smaller SMPM list size may be applied for this block, and vice versa. For example, if block size is smaller than 8×8 then the corresponding SMPM list size may be set to M=4,which could save 2 bits with the fixed length code and if block size is larger than 8×8 but smaller than 32×32 then the corresponding SMPM list size may be set to M=8.

In ECM-5.0, to signal an intra prediction mode corresponding to the last entry of the PMPM list uses a PMPM flag mpm_flag with 1 bin and a mpm index with 5 bins (in total 6 bins), and signaling an intra prediction mode from the SMPM list uses a PMPM flag mpm_flag with 1 bin, a SMPM flag smpm_flag with 1 bin and a mpm_index with 4 bins (in total also 6 bins). The binarization assign shorter bin string length to the intra prediction mode with higher probability. To avoid the situation where signaling an intra prediction mode from the SMPM list uses even shorter bin string than signaling one from the PMPM list, it is proposed in one variant that the reduced size of the SMPM list is dependent on the size of the PMPM list. For example, if block size is smaller than 8×8, the SMPM list size could only be reduced to 4 on condition that the corresponding PMPM list size is also reduced at least to 4.

In another embodiment, using a SMPM list or not is based on the block size and/or the (multi-type) tree depth of the current block to be encoded/decoded. In an example, a SMPM list would not be used for a block if the block size, e.g., width and/or height, of the current block is less than a specific number. The assumption here is that the intra prediction modes from the PMPM list is good enough for small blocks. For example, if a block size is smaller than 8×then there is no SMPM list but 61 non-MPM modes would be directly applied for this block. This could save signaling costs for a SMPM flag smpm_flag.

Normally, a most probable mode has a high probability to be selected as the optimal mode because of high correlation. In ECM-5.0, 22 MPM modes (from the PMPM and SMPM lists) may thus be enough to capture the intra prediction direction of a block, especially a block with small number of pixels to be predicted. If these 22 MPM modes are not being used, an index non mpm index is signaled using truncated binary code with 5 to 6 bits to indicate which of the remaining 45 non-MPM modes is applied. More precisely, each non-MPM index of the first 19 modes uses 5 bits for signaling, and each of the remained 26 non-MPM modes uses 6 bits. Thus, on average each mode uses 5.58 bits for its signaling. When filling the remaining 45 non-MPM modes, the order is from 45 degrees to −135 degrees in clockwise direction as depicted in FIG. 5. For small blocks, there is a minor prediction direction difference between mode 28 and mode 29. Therefore, if a smaller set of non-MPM modes can be applied for some small blocks, the bits consumed for representing the selected mode index can be further economized.

In an embodiment, the size of a non-MPM list is rendered dynamic, i.e. the size is for example adapted based on the block size and/or the (multi-type) tree depth of the current block to be encoded/decoded. For example, in a case where the block size, e.g., width and/or height, of the current block is less than a specific number, a smaller set of non-MPM modes would be applied for this block, and vice versa. If the block size is smaller than 32×32 then the corresponding non-MPM list size is set to M=23, meaning every two modes of the remaining 45 non-MPM modes are used to fill the non-MPM list for the current block. Since the length of non-MPM list is reduced to 23, it could just cost 4 to 5 bits to signal non_mpm_index with a truncated binary code. More precisely, each non-MPM index of the first 9 modes uses 4 bits for signaling, and each of the remained 14 non-MPM modes uses 5 bits, on average each mode uses 4.61 bits. Furthermore, if the block size is smaller than 8×8 then the corresponding non-MPM list size may be set to M=15, meaning every three modes of the remaining 45 non-MPM modes are used to fill the non-MPM list for the current block. It could just cost 3 to 4 bits to signal non_mpm_index with a truncated binary code. More precisely, the non-MPM index of the first mode may use 3 bits for its signaling, and each of the remaining 14 non-MPM modes uses 4 bits, on average each mode uses 3.93 bits.

In one variant, the size of the non-MPM list is dependent on the size of the PMPM list and/or the SMPM list. For example, if the current block size is smaller than 8×8, the non-MPM list size could only be reduced to 15 on condition that the corresponding SMPM list size is also reduced to 8 and PMPM list size is reduced to 5.

Moreover, the present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode re-sampling filter coefficients, re-sampling a decoded picture.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

This disclosure has described various pieces of information, such as for example syntax, that can be transmitted or stored, for example. This information can be packaged or arranged in a variety of manners, including for example manners common in video standards such as putting the information into an SPS (Sequence Parameter Set), a PPS (Picture Parameter Set), a NAL unit (Network Abstraction Layer), a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated with a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users. Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of re-sampling filter coefficients. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

Amendments to and listing of the claims:

1. An encoding method comprising:
obtaining an intra prediction mode for a current block to be encoded;
obtaining a list of intra prediction modes, wherein the list comprises a set of intra prediction modes ordered according to how frequently each intra prediction mode occurs and further adapted according to at least one characteristic of the current block selected from the group consisting of block size, block shape, and tree depth; and
encoding the intra prediction mode for the current block responsive to the list of intra prediction modes.

2. The method of claim 1, wherein the set of intra prediction modes is ordered in a decreasing order of frequency.

3. The method of claim 1, wherein the set of intra prediction modes is a set of intra prediction modes of neighboring blocks of the current block.

4-5. (canceled)

6. The method of claim 3, wherein the neighboring blocks comprise one block located at half position of a current block width and one block located at half position of a current block height.

7. The method of claim 3, wherein the neighboring blocks comprise blocks located at least one quarter position of a current block width and height.

8-10. (canceled)

11. The method of claim 3, wherein the list of intra prediction modes comprises, after the set of intra prediction modes of neighboring blocks, at least one intra prediction mode of another ordered list of default intra prediction modes whose order depends on a shape of the current block.

12. The method of claim 1, wherein a size of the list depends on a size of the current block or on a tree-depth associated with the current block.

13. (canceled)

14. A decoding method comprising:
obtaining encoded data for a current block to be decoded;
obtaining a list of intra prediction modes wherein the list comprises a set of intra prediction modes ordered according to how frequently each intra prediction mode occurs and further adapted according to at least one characteristic of the current block selected from the group consisting of block size, block shape, and tree depth; and
decoding an intra prediction mode from the encoded data responsive to the list of intra prediction modes.

15. The method of claim 14, wherein the set of intra prediction modes is ordered in a decreasing order of frequency.

16. The method of claim 14, wherein the set of intra prediction modes is a set of intra prediction modes of neighboring blocks of the current block. 17-18. (canceled)

19. The method of claim 16, wherein the neighboring blocks comprise one block located at half position of a current block width and one block located at half position of a current block height.

20. The method of claim 16, wherein the neighboring blocks comprise blocks located at least one quarter position of a current block width and height. 21-23. (canceled)

24. The method of claim 16, wherein the list of intra prediction modes comprises, after the set of intra prediction modes of neighboring blocks, at least one intra prediction mode of another ordered list of default intra prediction modes whose order depends on a shape of the current block.

25. The method of claim 14, wherein a size of the list depends on a size of the current block or on a tree-depth associated with the current block.

26. (canceled)

27. An encoding apparatus comprising one or more processors and at least one memory coupled to the one or more processors, wherein the one or more processors are configured to perform.;
obtaining intra prediction mode for a current block to be encoded;
obtaining a list of intra prediction modes, wherein the list comprises a set of intra prediction modes ordered according to how frequently each intra prediction mode occurs and further adapted according to at least one characteristic of the current block selected from the group consisting of block size, block shape, and tree depth, &
encoding the intra prediction mode for the current block responsive to the list of intra prediction modes.

28. A decoding apparatus comprising one or more processors and at least one memory coupled to the one or more processors, wherein the one or more processors are configured to perform;
obtaining encoded data for a current block to be decoded;
obtaining a list of intra prediction modes, wherein the list comprises a set of intra prediction modes ordered according to how frequently each intra prediction mode occurs and further adapted according to at least one characteristic of the current block selected from the group consisting of block size, block shape, and tree depth; and
decoding an intra prediction mode from the encoded data responsive to the list of intra prediction modes.

29-30. (canceled)

31. The encoding apparatus of claim 27, wherein the set of intra prediction modes is a set of intra prediction modes of neighboring blocks of the current block, and wherein the neighboring blocks comprise one block located at half position of a current block width and one block located at half position of a current block height.

32. The encoding apparatus of claim 27, wherein the set of intra prediction modes is a set of intra prediction modes of neighboring blocks of the current block, and wherein the neighboring blocks comprise blocks located at least one quarter position of a current block width and height.

33. The encoding apparatus of claim 27, wherein the set of intra prediction modes is a set of intra prediction modes of neighboring blocks of the current block, and wherein the list of intra prediction modes comprises, after the set of intra prediction modes of neighboring blocks, at least one intra prediction mode of another ordered list of default intra prediction modes whose order depends on a shape of the current block.

34. The encoding apparatus of claim 27, wherein a size of the list depends on a size of the current block or on a tree-depth associated with the current block.

35. The decoding apparatus of claim 28, wherein the set of intra prediction modes is a set of intra prediction modes of neighboring blocks of the current block, and wherein the neighboring blocks comprise one block located at half position of a current block width and one block located at half position of a current block height.

36. The decoding apparatus of claim 28, wherein the set of intra prediction modes is a set of intra prediction modes of neighboring blocks of the current block, and wherein the neighboring blocks comprise blocks located at least one quarter position of a current block width and height.

37. The decoding apparatus of claim 28, wherein the set of intra prediction modes is a set of intra prediction modes of neighboring blocks of the current block, and wherein the list of intra prediction modes comprises, after the set of intra prediction modes of neighboring blocks, at least one intra prediction mode of another ordered list of default intra prediction modes whose order depends on a shape of the current block.

38. The decoding apparatus of claim 28, wherein a size of the list depends on a size of the current block or on a tree-depth associated with the current block.
